(19) United States
(12) Patent Application Publication
(10) Pub. No.: US 2007/0150134 A1
(43) Pub. Date: Jun. 28, 2007

(54) Driving support systems, methods, and programs

(75) Inventor: Yukio Yamamoto, Anjo (JP)

Correspondence Address: OLIFF & BERRIDGE, PLC, P.O. BOX 19928, ALEXANDRIA, VA, 22320, US

(73) Assignee: AISIN AW CO., LTD, ANJO-SHI (JP)

(21) Appl. No.: 11/640,214

(22) Filed: Dec. 18, 2006

(30) Foreign Application Priority Data
Dec. 26, 2005 (JP) 2005-372583

(51) Int. Cl. G01M 17/00

(52) U.S. Cl. 701/30; 701/93

(57) ABSTRACT

Driving support systems, methods, and programs for a host vehicle receive braking information from another vehicle traveling in front of the host vehicle. The systems, methods, and programs obtain current speed information of the host vehicle and obtain inter-vehicle distance information indicating a distance between the other vehicle and the host vehicle. The systems, methods, and programs generate host vehicle braking information based on the other vehicle braking information, the vehicle speed information, and the inter-vehicle distance information, the host vehicle braking information recommending a braking operation for the host vehicle. Based on the host vehicle braking information, the systems, methods, and programs control the host vehicle.

### INCORPORATION BY REFERENCE

The disclosure of Japanese Patent Application No. JP2005-372583, filed on Dec. 26, 2005, including the specification, drawings, and abstract is incorporated herein by reference in its entirety.

### BACKGROUND

1. Related Technical Fields

Related technical fields include driving support devices, driving support systems, driving support methods, and driving support programs that assist the driving of a vehicle based on information from other vehicles.

2. Related Art

Conventional devices control the traveling of a vehicle based on information relating to another vehicle traveling in front of the controlled vehicle (see, e.g., Japanese Patent Application Publication No. JP-A-2003-104184). According to such devices, another vehicle traveling in front of the controlled vehicle is detected by detecting the speed (vehicle speed) of the other vehicle and the distance (inter-vehicle distance) between the other vehicle and the controlled vehicle using a vehicle speed sensor and a radar device. When the other vehicle has been detected and a trigger switch is manipulated by a driver, a brake actuator is controlled based on the detected speed and inter-vehicle distance information, thereby enabling “auto-cruise control.”

### SUMMARY

However, according to the above-described devices, the detected information (vehicle speed and inter-vehicle distance) is limited to information that can be detected at the present moment. Therefore, if a vehicle traveling in front (the front vehicle) brakes suddenly, for example, traveling control of the controlled vehicle cannot always be performed appropriately. In other words, it may be difficult to predict the future behavior of the front vehicle using only detection information obtained from detection devices such as a radar device and a vehicle speed sensor. As a result, in conventional auto-cruise control, it is difficult to respond sufficiently to sudden changes in the behavior of the front vehicle.

### SUMMARY

Exemplary implementations of the broad principles described herein provide systems, methods, and programs that enable appropriate driving support.

Exemplary implementations provide driving support systems, methods, and programs for a host vehicle that may receive braking information from another vehicle traveling in front of the host vehicle. The systems, methods, and programs may obtain current speed information of the host vehicle and may obtain inter-vehicle distance information indicating a distance between the other vehicle and the host vehicle. The systems, methods, and programs may generate host vehicle braking information based on the other vehicle braking information, the vehicle speed information, and the inter-vehicle distance information, the host vehicle braking information recommending a braking operation for the host vehicle. Based on the host vehicle braking information, the systems, methods, and programs may control the host vehicle.

### BRIEF DESCRIPTION OF THE DRAWINGS

Exemplary implementations will now be described with reference to the accompanying drawings, wherein:

FIGS. 1A and 1B shows an exemplary driving support system;

FIG. 2 shows an exemplary navigation device in another vehicle as an exemplary driving support system;

FIG. 3 shows an exemplary navigation device in a controlled vehicle as an exemplary driving support system;

FIG. 4 is a flowchart showing an exemplary navigation method;

FIG. 5 is a flowchart showing an exemplary braking information processing method;

FIG. 6 is an illustrative view showing an exemplary braking distance calculation method;

FIG. 7 is a flowchart showing an exemplary driving support method; and

FIGS. 8A-8C is an illustrative view showing an exemplary output of the method of FIG. 7.

### DETAILED DESCRIPTION OF EXEMPLARY IMPLEMENTATIONS

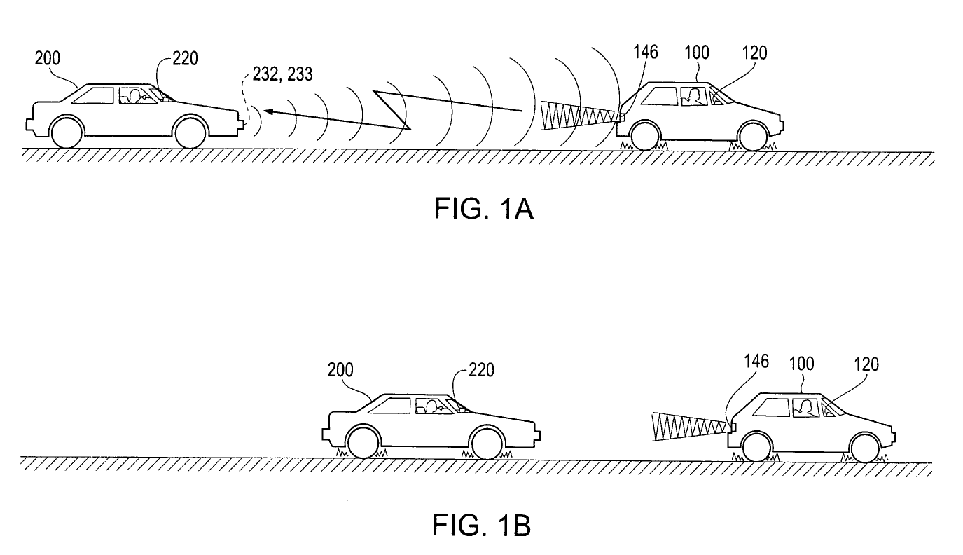

Examples of driving support devices, driving support systems, driving support methods, and driving support programs will be described below based on the drawings. According to the examples, the driving support system may be embodied as a navigation device installed in a vehicle. First, an outline of the structure of the driving support system will be described with reference to FIGS. 1A and 1B.

As shown in FIG. 1A, the driving support system may be constituted by a front vehicle navigation device 120 installed in another vehicle (another/other vehicle 100) traveling in front of a controlled vehicle (host vehicle 200), having a rear vehicle navigation device 220 installed in the host vehicle 200. Exemplary structure of these navigation devices 120, 220 will be described later.

The navigation device 120 installed in the other vehicle 100 may generate other vehicle braking information relating to a braking operation of the other vehicle 100, and may output this information to the exterior of the other vehicle 100, for example, rearward via a brake lamp 146. In the navigation device 220 installed in the host vehicle 200 traveling behind the other vehicle 100, the other vehicle braking information output by the navigation device 120 may be obtained by a front camera 233 or the like. An inter-vehicle distance information regarding the distance between the host vehicle 200 and the other vehicle 100 and vehicle speed information relating to the host vehicle 200 may be obtained from, for example, a millimeter wave radar 232 and/or a sensor control ECU. Based on this information, host vehicle braking information relating to a braking operation of the host vehicle 200 may be generated.

Thus, in the host vehicle 200, the host vehicle braking information may be generated based on the other vehicle braking information obtained from the other vehicle 100 in addition to the vehicle speed information of the host vehicle 200 and the inter-vehicle distance information regarding the distance between the host vehicle 200 and the other vehicle 100. Therefore, for example, more accurate host vehicle braking information can be generated. That is, when the other vehicle 100 traveling in front of the host vehicle 200 brakes suddenly, appropriate driving support can be provided to the driver or the like of the host vehicle based on the host vehicle braking information (FIG. 1A). As a result, contact with the other vehicle 100 can be reliably avoided (FIG. 1B).

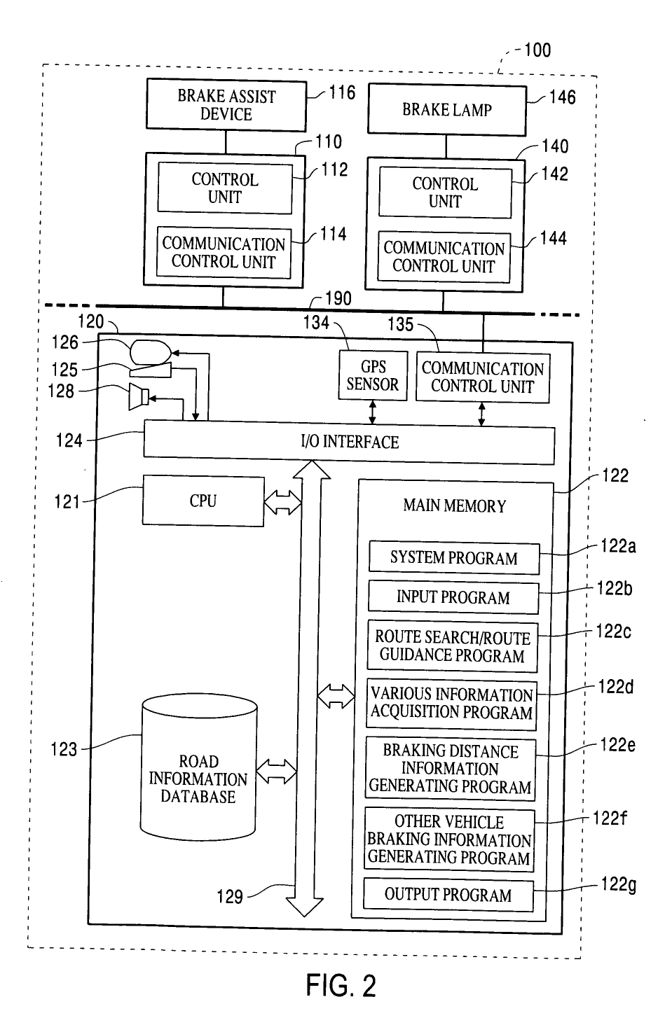

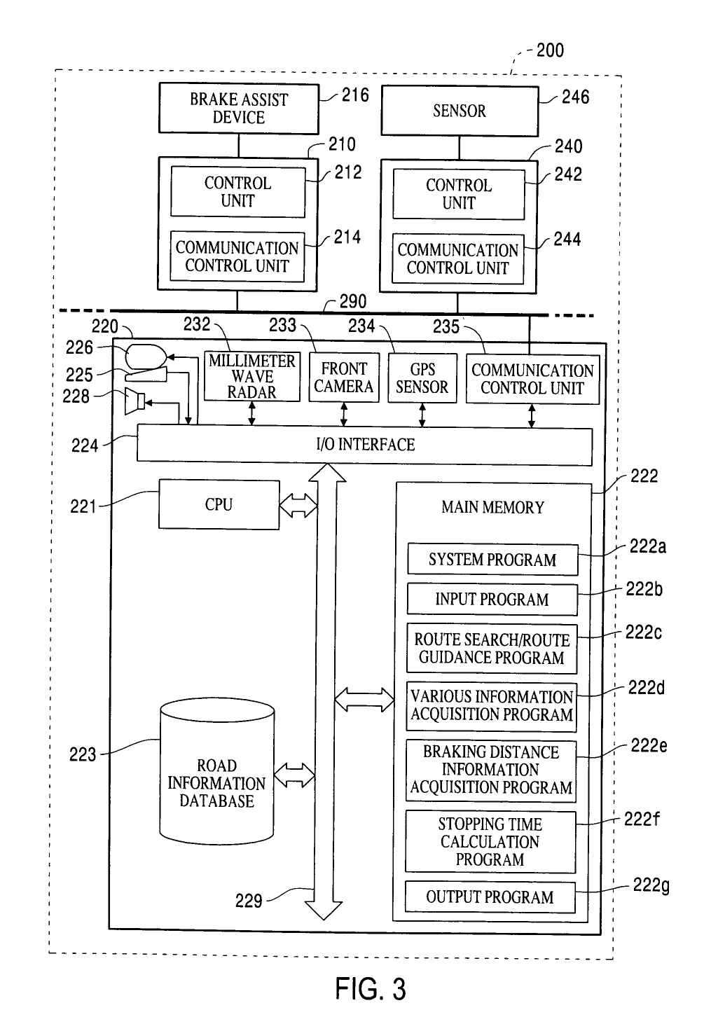

Next, exemplary structures of the navigation device 120 and the navigation device 220 will be described with reference to FIG. 2 and FIG. 3.

As shown in FIG. 2, the navigation device 120 installed in the other vehicle 100 may be constituted by, for example, a controller (CPU 121), a main memory 122, a road information database 123, an input/output interface 124, an input device 125, a display 126, a sound source unit 128, a GPS sensor 134, and/or a communication control unit 135. Note that in addition to the navigation device 120, FIG. 2 shows a brake assist ECU 110 and a lamp control ECU 140, which may be connected to an in-vehicle LAN 190 via the communication control unit 135.

The navigation device 120 may be structured to be capable of realizing the functions of, for example, a computer through the CPU 121, main memory 122, road information database 123, input/output interface 124, input device 125, display 126, and so on. The hardware may be structured in the following manner.

The CPU 121 may be a central processing unit for controlling the navigation device 120, and may be connected to the main memory 122, road information database 123, and/or input/output interface 124, via a system bus 129 (constituted by, for example, an address bus and/or a data bus). The main memory 122 may store, for example, a system program 122a for controlling the CPU 121 and/or various control programs 122b to 122g. The CPU 121 may read these programs from the main memory 122 and executes them, for example, in sequence.

The main memory 122 may be, for example, a semiconductor storage device connected to the system bus 129, and may constitute a main storage space (ROM, RAM, and so on) used by the CPU 121. Various program data and setting data, etc., pertaining thereto for the system program 122a, an input program 122b, a route search/route guidance program 122c, a various information acquisition program 122d, a braking distance information generating program 122e, an other vehicle braking information generating program 122f, and/or an output program 122g may be written into the main memory 122 in advance.

The road information database 123 may be an information storage medium (road information storage device) such as a hard disk, a compact disk, or a digital versatile disk constituting an auxiliary storage space used by the CPU 121, and may be connected to the CPU 121 via the system bus 129. The road information database 123 may store road information such as map data and road data used for route search/route guidance (to be described below) and to generate the other vehicle braking information. Here, the “road data” include various data relating to topographic features such as roads and rivers, road links (numbers, link lengths, link turning angles, gradient values, etc.), nodes (numbers, coordinates, etc.), and so on.

As used herein, the term “link” refers to, for example, a road or portion of a road. For example, according to one type of road data, each road may consist of a plurality of componential units called links. Each link may be separated and defined by, for example, an intersection, an intersection having more than three roads, a curve, and/or a point at which the road type changes. As used herein the term “node” refers to a point connecting two links. A node may be, for example, an intersection, an intersection having more than three roads, a curve, and/or a point at which the road type changes.

The input/output interface 124 may be a device for mediating data exchange between an input device such as the input device 125, the display 126, the sound source unit 128, the GPS sensor 134, the communication control unit 135, and/or the CPU 121, and may be connected to the system bus 129.

The input device 125 may be an input device provided on an operating panel of the navigation device 120, and may be connected to the system bus 129 via the input/output interface 124. The input device 125 may input data relating to, for example, a destination and/or an origin, of a journey for which the driver or passenger of the other vehicle 100 requires route guidance via the input program 122b.

The display 126 may be a display device that is capable of outputting, for example, a guided route from the origin to the destination and/or travel information relating to the route along which the vehicle is currently traveling, via the output program 122g, and may be provided on the operating panel of the navigation device 120. The display 126 may also be connected to the system bus 129 via the input/output interface 124, and may be constituted, for example, by a liquid crystal display or the like.

The sound source unit 128 may be capable of converting a digital signal based on predetermined sound information into an analog signal, and then generating audible sound from the analog signal and outputting the audible sound through a speaker via an amplifier. The sound source unit 128 may be connected to the system bus 129 via the input/output interface 124. Thus, spoken route guidance or the like may be output through the speaker and provided to the driver and passenger.

The GPS sensor 134 may be used to output current vehicle position information according to, for example, longitude/latitude, and may be connected to the system bus 129 via the input/output interface 124. The GPS sensor 134 may be constituted by a GPS receiver or the like, which receives signals from a plurality of GPS satellites and measures the absolute position of the vehicle.

The communication control unit 135 may be a LAN controller that can be connected to the in-vehicle LAN 190, such as a CAN (Controller Area Network) or LIN (Local Interconnect Network. The communication control unit 135 may be connected to the system bus 129 via the input/output interface 124. The communication control unit 135 may enable data communication between, for example, the CPU 121 and the brake assist ECU 110, the lamp control ECU 140, and/or a sensor ECU (not shown) via the in-vehicle LAN 190.

The brake assist ECU 110 connected to the in-vehicle LAN 190 may be mainly constituted by a control unit 112 and a communication control unit 114, and may be capable of controlling, for example, a brake assist device 116 and an engine control device, not shown in the drawing, that are connected thereto. For example, the brake assist device 116 may be a device for increasing the braking force by supplementing the brake depression force (brake pressure) when a strong braking force is required, for example, during emergency braking. The engine control device may be a device that is capable of controlling engine acceleration and deceleration by controlling the opening of a throttle valve and the fuel injection amount injected through a fuel injection valve to adjust the air-fuel ratio of air and fuel supplied to cylinders in the engine. The brake assist 110 may be capable of transmitting information regarding the brake pressure and acceleration/deceleration information to the navigation device 120, and receiving brake control information transmitted from another device such as the navigation device 120.

The lamp control ECU 140 connected to the in-vehicle LAN 190 may also be mainly constituted by a control unit 142 and a communication control unit 144, and may be capable of illuminating and extinguishing the brake lamp 146 connected thereto. The brake lamp 146 may be capable of transmitting optical data toward the rear of the other vehicle 100 using light as a transmission medium. For this purpose, the brake lamp 146 may include a light-emitting element (for example, a high intensity LED or an infrared LED) serving as a light-emitting device other than as a normal brake lamp, which enables, for example, binary data modulation via the intensity, color, illumination/extinguishment intervals, and so on of the light. Note that a communication function required for binary data modulation and so on may be provided in the control unit 142, for example, according to the technique disclosed in Japanese Patent Application Publication No. JP-A-11-53689, or the like.

The system program 122a, input program 122b, route search/route guidance program 122c, various information acquisition program 122d, braking distance information generating program 122e, other vehicle braking information generating program 122f, and/or output program 122g, all of which may be stored in the main memory 122, may be used to implement various methods.

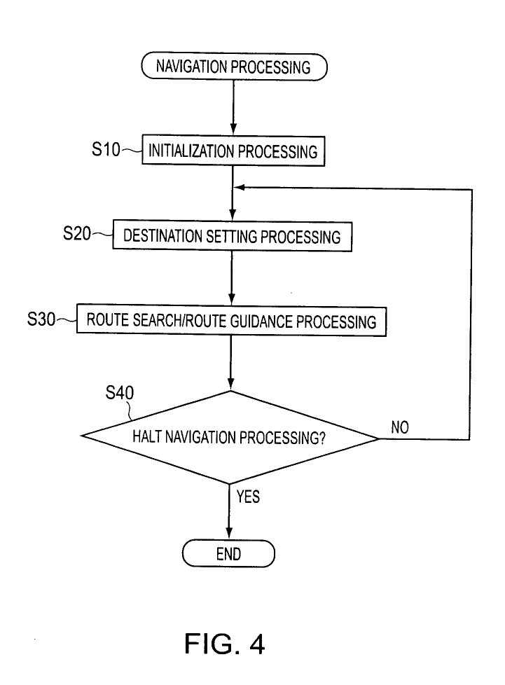

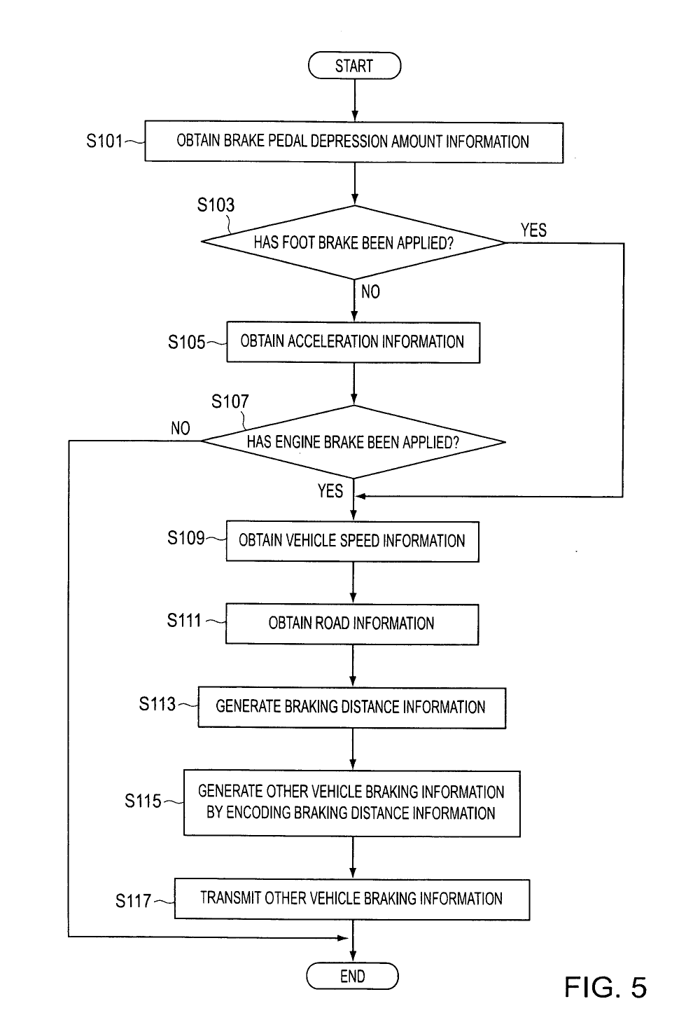

The system program 122a corresponds to a basic program for controlling each function performed from activation to shutdown of the navigation device 120, i.e. a navigation function (such the exemplary method of FIG. 4), an other vehicle braking information provision function (such the exemplary method of FIG. 5), and so on, and performing a series of memory management processes relating to data exchange between the various programs via the main memory 122 and so on.

The input program 122b may have a function for causing the driver or passenger to input data relating to a destination for which the driver or passenger requires route guidance, a point of origin, and so on, as well as various other data required during use of the navigation function, via the input device 125, and transferring these data to another program, process, or the like. The input program 122b may also have a function for transferring road information output by the road information database 123, current position information output by the GPS sensor 134, brake pressure information input from the brake assist ECU 110 via the communication control unit 135, and so on to another program, process, or the like.

The route search/route guidance program 122c may manage the navigation function, such as the basic functions of the navigation device 120, and may serve to search for a recommended route or the like and provide the driver or passenger with guidance along the found route. Specifically, the route search/route guidance program 122c may have a function for searching for a destination input through the input device 125 based on the map data in the road information database 123, a function for searching for a route to the destination from a point of origin input through the input device 125 or the current location of the vehicle detected by the GPS sensor 134 based on the road data in the road information database 123, and a function for outputting data relating to the found route (for example, an explanation of the advancement direction, such as right and left turns, road traffic information, and so on) via the display 126 and the sound source unit 128.

The various information acquisition program 122d may have a function for acquiring various information from the peripheral devices of the CPU 121. More specifically, the various information acquisition program 122d may acquire navigation-related setting information input from the input device 125, road information input from the road information database 123, current position information input from the GPS sensor 134, brake pressure information input from the brake assist ECU 110 via the communication control unit 135, vehicle speed information input from the sensor ECU, not shown in the drawing, and so on.

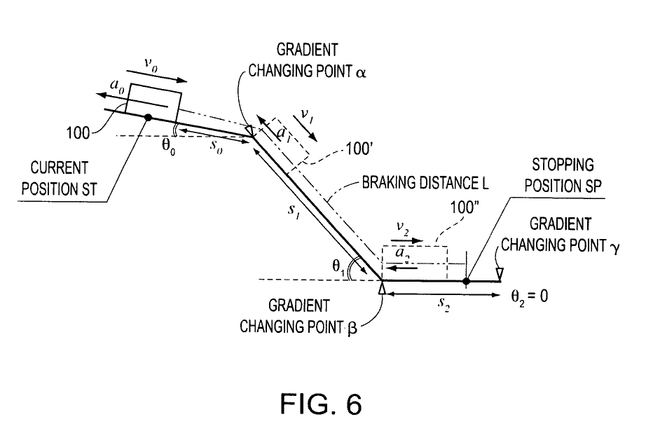

The braking distance information generating program 122e may have a function for calculating the braking distance of the other vehicle 100 and generating braking distance information based on current vehicle speed information relating to the other vehicle 100, obtained from the sensor ECU, current position information relating to the other vehicle 100, obtained from the GPS sensor 134, and road information relating to the road along which the other vehicle 100 is currently traveling, obtained from the road information database 123. Braking distance calculation processing, fore example, performed by the braking distance information generating program 122e will be described in detail below with reference to FIG. 6.

The other vehicle braking information generating program 122f may have a function for generating the other vehicle braking information by encoding the braking distance information generated by the braking distance information generating program 122e, and thereby may generate a data string that can be transmitted to the rear host vehicle 200 via the lamp control ECU 140. For example, a braking distance expressed in 0.1 meter units may be converted into binary data, whereupon other vehicle braking information attached with an error-detectable check sum detection code, an error-correctable cyclic redundancy check code, and so on, may be generated.

The output program 122g may have a function for rendering various screen data on the display 126 in the form of diagrams and a function for causing the sound source unit 128 to output various guidance data through the speaker, or a function for outputting the other vehicle braking information generated by the other vehicle braking information generating program 122f to the lamp control ECU 140 via the communication control unit 135.

In relation to the navigation device 120 of the other vehicle 100, structured as described above, the navigation device 220 installed in the host vehicle 200 may be structured as shown in FIG. 3. Note that the navigation device 220 may also be based on a navigation function, similarly to the navigation device 120, and therefore may have substantially identical basic structure to the navigation device 120.

Accordingly, the navigation device 220 may also be constituted mainly by, for example, a controller (CPU 221), a main memory 222, a road information database 223, an input/output interface 224, an input device 225, a display 226, a sound source unit 228, a GPS sensor 234, a communication control unit 235, and so on. However, the navigation device 220 may differ from the navigation device 120 by, for example, further including sensors such as a millimeter wave radar 232 and a front camera 233, as peripheral devices of the CPU 221. Note that in FIG. 3, a brake assist ECU 210 and a sensor control ECU 240, which are connected to an in-vehicle LAN 290 via the communication control unit 235, are shown in addition to the navigation device 220.

The CPU 221, main memory 222, road information database 223, input/output interface 224, input device 225, display 226, GPS sensor 234, and communication control unit 235 may be structured identically to the CPU 121, main memory 122, road information database 123, input/output interface 124, input device 125, display 126, GPS sensor 134, and communication control unit 135 of the navigation device 120, respectively, and therefore descriptions of specific structural examples thereof have been omitted.

According to this example, the navigation device 220 needs to obtain information relating to the inter-vehicle distance between the host vehicle 200 and the other vehicle 100 traveling in front, as described with reference to FIG. 1A, and therefore the millimeter wave radar 232 may measure the distance to the other vehicle 100 positioned in front of the host vehicle 200 (inter-vehicle distance information) from a time difference and phase difference based on a transmission wave and a reflection wave, and may outputs the information to the CPU 221.

The front camera 233 may capture a rear portion image including the brake lamp 146 of the other vehicle 100 traveling in front, may demodulate binary data modulated through the intensity, color, illumination/extinguishment interval, and so on of the illumination light of the brake lamp 146, included in information relating to the captured image, and may output the data to the CPU 221 as the other vehicle braking information. The image information may also be output to the CPU 221.

The brake assist ECU 210 and the sensor control ECU 240 may also be connected to the navigation device 220 via the in-vehicle LAN 290. The brake assist ECU 220 may be substantially identical to the brake assist ECU 110 of the other vehicle 100 in that it is mainly constituted by a control unit 212 and a communication control unit 214, and is capable of controlling a brake assist device 216 and an engine control device (not shown) that are connected thereto. In the navigation device 220 installed in the host vehicle 200, by outputting host vehicle braking information generated through driving assistance processing to the brake assist ECU 210, forcible braking control may be performed when there is not enough time for the driver of the host vehicle 200 to perform a braking operation, as will be described below.

The sensor control ECU 240 may be constituted mainly by a control unit 242 and a communication control unit 244, and may be capable of controlling various sensors 246 (for example, a vehicle speed sensor, a G sensor, and so on) connected thereto. Note that the millimeter wave radar 232 and front camera 233 may be provided in the navigation device 220, but by replacing the sensors 246 of the sensor control ECU 240 with the millimeter wave radar and front camera, for example, the millimeter wave radar 232 and front camera 233 can be provided separately from the navigation device 220. In so doing, the need to provide the millimeter wave radar and so on in the main body of the navigation device 220 is eliminated, and hence various sensor devices, such as a millimeter wave radar and a front camera, can be attached respectively in appropriate positions.

An outline of the various programs stored in the main memory 222 of the navigation device 220 will now be described. Note that a system program 222a, an input program 222b, a route search/route guidance program 222c, a various information acquisition program 222d, and an output program 222g are structured substantially identically to the system program 122a, input program 122b, route search/route guidance program 122c, various information acquisition program 122d, and output program 122g of the navigation device 120, and hence description thereof has been omitted. Here, the unique software of the navigation device 220, namely a braking distance information acquisition program 222e and a stopping time calculation program 222f, will be described.

The braking distance information acquisition program 222e may have a function for obtaining the binary data output by the front camera 233 (other vehicle braking information) via the input program 222b, and obtaining braking distance information (the braking distance of the other vehicle 100) by decoding the other vehicle braking information.

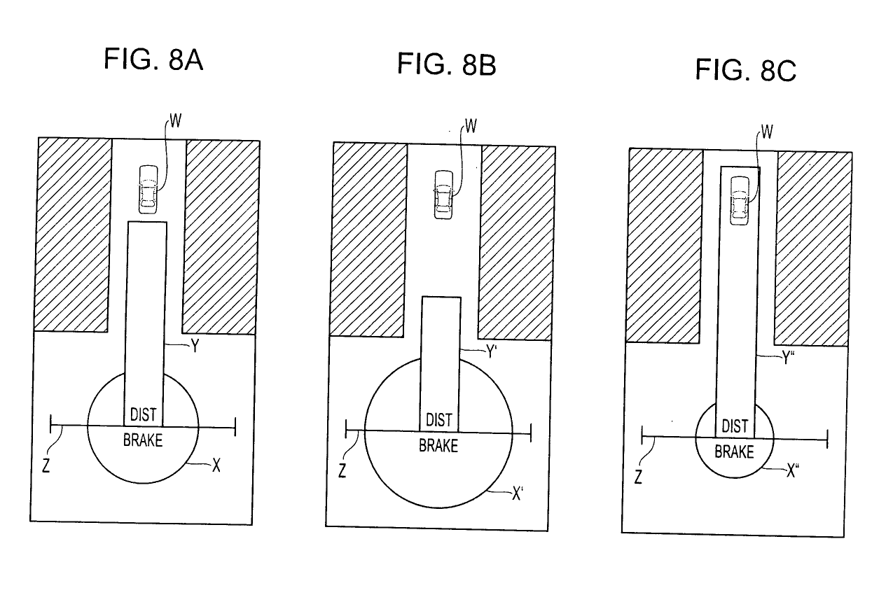

The stopping time calculation program 222f may have a function for calculating a braking time of the host vehicle 200 (the time required for the host vehicle 200 to come to a standstill from the start of a braking operation, hereafter “stopping time”) based on vehicle speed information, the inter-vehicle distance information, the braking distance information of the other vehicle 100. Processing for calculating the stopping time will may be done, for example, by the method described in detail below with reference to FIG. 8.

Next, an exemplary navigation method will be described with reference to FIG. 4. The navigation processing executed by the navigation device 120 and the navigation device 220 may be done based on the method of FIG. 4. That is, the exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure.

Note that the exemplary method may apply equally to the processing content of the navigation device 120 installed in the other vehicle 100 and the navigation device 220 installed in the host vehicle 200.

Typically, the navigation device 120 is structured such that a main power source of the navigation device 120 is activated as the engine of the vehicle starts (the ignition switch turns ON), and therefore the navigation processing is set to be activated automatically by the system program 122a as soon as the main power source turns ON.

As shown in FIG. 4, in step S10, predetermined work area is secured in the main memory 122 or various flags and the like are set at their initial values. Next, in step S20, destination data, preferred route data, and so on, which relate to route search conditions and the like such as the destination and points of passage, are input through the input device 125 by a driver operation, for example. Note that this processing may be performed by the input program 122b.

Next, in a step S30, a shortest route from the current position of the vehicle, obtained by the GPS sensor 134, to the destination set in the step S20, for example, is searched using a search algorithm such as the Dijkstra method, based on the map data and road data in the road information database 123. This processing may be performed by the route search/route guidance program 122c. Information relating to the found route (for example, a description of the advancement direction, such as right and left turns) may then be output as an image displayed on the display 126 and a synthesized voice or the like generated by the sound source unit 128. Thus, the driver or passenger can be provided with route guidance.

In step S40 it is determined whether a request has been issued to halt the method. Specifically, for example, when the vehicle reaches its destination, the driver usually parks the vehicle and exits, and at this time, the main power source of the navigation device 120 is cut as the engine is stopped. Thus, in the step S40, a determination may be made based on an engine stop signal (an ignition switch OFF signal) obtained directly before the main power source of the navigation device 120 is cut as to whether the vehicle has stopped, i.e., whether to halt the navigation processing.

When a request to halt the navigation processing has been issued (Yes in S40), data to be held in the non-volatile semiconductor storage device of a battery backed-up memory device or the like may be stored. When a request to halt the navigation processing has not been issued (No in S40), the method returns to step S20, where processing is performed to encourage the driver or the like to input destination information and so on.

Next, an exemplary braking information processing method will be described with reference to FIGS. 5 and 6. Again, the exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure.

That is, the exemplary method may be executed by the system program 122a, input program 122b, various information acquisition program 122d, braking distance information generating program 122e, other vehicle braking information generating program 122f, and output program 122g in parallel with the navigation processing described above, and similarly to the navigation processing described above.

The method may be activated automatically by the system program 122a immediately after the navigation device 120 is activated. Upon completion, the series of processes is executed repeatedly from the beginning until an engine stop signal is input.

As shown in FIG. 5, in a step S101, brake pedal depression amount information is obtained. Specifically, brake pressure information transmitted by the brake assist ECU 110 may be obtained via the various information acquisition program 122d.

Next, in a step S103, it is determined whether a foot brake has been applied. Specifically, a determination is made based on the brake pressure information obtained in the step S101 as to whether the foot brake has been applied by the driver of the other vehicle 100, for example, by determining whether a brake pressure value exceeds a predetermined value. When the brake pressure value exceeds the predetermined value, it is determined that the foot brake has been applied (Yes in S103), and when the brake pressure value does not exceed the predetermined value, it is determined that the foot brake has not been applied (No in S103).

When it is determined in the step S103 that the foot brake has been applied (Yes in S103), the processing advances to step S109, and when it is determined that the foot brake has not been applied (No in S103), the processing advances to step S105, where acceleration information is obtained.

In step S105, for example, the acceleration information may be obtained by implementing computation processing for time-differentiating the vehicle speed information input by the sensor ECU, via the various information acquisition program 122d. Alternatively, the acceleration information may be obtained by obtaining acceleration information output by the brake assist ECU 110 via the various information acquisition program 122d.

Next, in step S107, it is determined whether an engine brake has been applied. The determination may be made based on the acceleration information obtained in step S105, and may be performed by determining whether the vehicle is accelerating or decelerating. When the vehicle is decelerating, it is determined that the engine brake has been applied (Yes in S107), and when the vehicle is accelerating, it is determined that the engine brake has not been applied (No in S107).

When it is determined in the step S107 that the engine brake has been applied (Yes in S107), in step S109, vehicle speed information is obtained. When it is determined that the engine brake has not been applied (No in S107), the other vehicle 100 is determined to not be in a braking state, and the method is terminated. However, as noted above, this method may be executed repeatedly from the beginning until an engine stop signal is input.

In step S109, the vehicle speed information relating to the current vehicle speed of the other vehicle 100 is obtained from the sensor ECU, via the various information acquisition program 122d.

Next, in step S111, road information is obtained. For example, road data such as the gradient value of the road along which the other vehicle 100 is currently traveling may be obtained from the road information stored in the road information database 123. For this purpose, first the current position information of the other vehicle 100 may be obtained from the GPS sensor 134, and road data (gradient value and so on) corresponding to longitude/latitude coordinate information based on the current position information may be obtained from the road information database 123. Note that this information may be obtained via the various information acquisition program 122d.

Once the current vehicle speed information of the other vehicle 100 and the gradient value and so on of the road along which the other vehicle 100 is traveling have been obtained, in step S113, braking distance information is generated. This processing may be performed by the braking distance information generating program 122e. Calculation of the braking distance can be understood more easily by referring to the illustrative diagram in FIG. 6, and hence description will be provided with reference to FIG. 6.

FIG. 6 is an illustrative view showing an exemplary method of calculating the braking distance taking the gradient into account. In FIG. 6, the other vehicle 100 is currently positioned on a road having a gradient angle of θ₀, and is traveling at a vehicle speed v₀ and an acceleration of a₀.

Assuming here that the current vehicle speed is vₙ and the acceleration is aₙ, a braking distance S can typically be determined from the following Equation (1).

$$S = \frac{- {v}_{n}^{2}}{2 {a}_{n}} \qquad ( 1 )$$

When the braking distance S determined in Equation (1) is greater than a distance Sₙ to the next gradient changing point (n−1), a vehicle speed vₙ₊₁ and an acceleration an+1 immediately after the gradient changing point (n−1) are determined from the following Equations (2) and (3). Note that the vehicle speed vₙ₊₁ and acceleration aₙ₊₁ are determined through estimation calculation. Further, θₙ denotes the gradient angle at the next gradient changing point (n−1), θₙ₊₁ denotes the gradient angle at the next gradient changing point n thereto, and g denotes gravitational acceleration.
v_{b+1}+\sqrt{2aₙsₙ+vₙ²} (2)
aₙ₊₁=aₙ+g sin(θₙ₊₁−θₙ) (3)

By inserting the vehicle speed vₙ₊₁ and the acceleration aₙ₊₁, determined in this manner, into Equation (1), the braking distance S immediately after the gradient changing point (n−1) may be determined, and therefore, when the determined braking distance S is greater than a distance Sₙ₊₁ to the next gradient changing point n, the braking distance S is determined again using Equations (2) and (1). In other words, the braking distance S may be determined continuously using Equations (2) and (1) until the determined braking distance S becomes smaller than the distance Sₙ₊ₘ, to the next gradient changing point n+m. By determining the sum total of the braking distance S determined in this manner using the following Equation (4), a braking distance L from a current position ST to a stopping position SP can be calculated, or in other words the braking distance information can be generated.

$$L = {\sum }_{n = 0}^{m - 1} {S}_{n} + S \qquad ( 4 )$$

In the example shown in FIG. 6, for example, when the vehicle speed and acceleration of the other vehicle 100 at the current position ST are v₀ and a₀, respectively, and the braking distance S is determined using Equation (1), the braking distance S is greater than a distance S₀ from the current position ST to the next gradient changing point α, and therefore a vehicle speed v₁ and an acceleration a₁ immediately after the gradient changing point a are determined using Equations (2) and (3). The braking distance S immediately after the gradient changing point α is then determined by inserting the determined vehicle speed v₁ and acceleration a₁ into Equation (1). As a result, the braking distance S is also greater than a distance S₁ immediately after the gradient changing point α to the next gradient changing point β, and hence the braking distance S immediately after the gradient changing point β is determined in a similar manner. This braking distance S is smaller than a distance S₂ immediately after the gradient changing point β to the next gradient changing point γ, and therefore the braking distance L from the current position ST to the stopping position SP is determined as S₀+S₁+S.

Once the braking distance has been determined in this manner in step S113, in step S115, generate other vehicle braking information is generated, for example, by encoding the braking distance information. This processing may be performed by the other vehicle braking information generating program 122f, and involves converting the braking distance information generated in the step S113 into a binary data string that can be transmitted to the rear host vehicle 200 via the lamp control ECU 140, and then generating the other vehicle braking information by attaching an error-detectable check sum detection code, an error-correctable cyclic redundancy check code, and so on, for example.

In a step S117, the other vehicle braking information is transmitted. This may be performed by having the output program 122g transmit the other vehicle braking information generated in the step S115 to the lamp control ECU 140 via the communication control unit 135. Once the processing of the step S117 is complete, the method ends. As noted above, however, the method may be executed repeatedly from the start until an engine stop signal is input. As also noted above, the lamp control ECU 140, having received the other vehicle braking information, may transmit the other vehicle braking information toward the rear host vehicle 200 through optical data transmission.

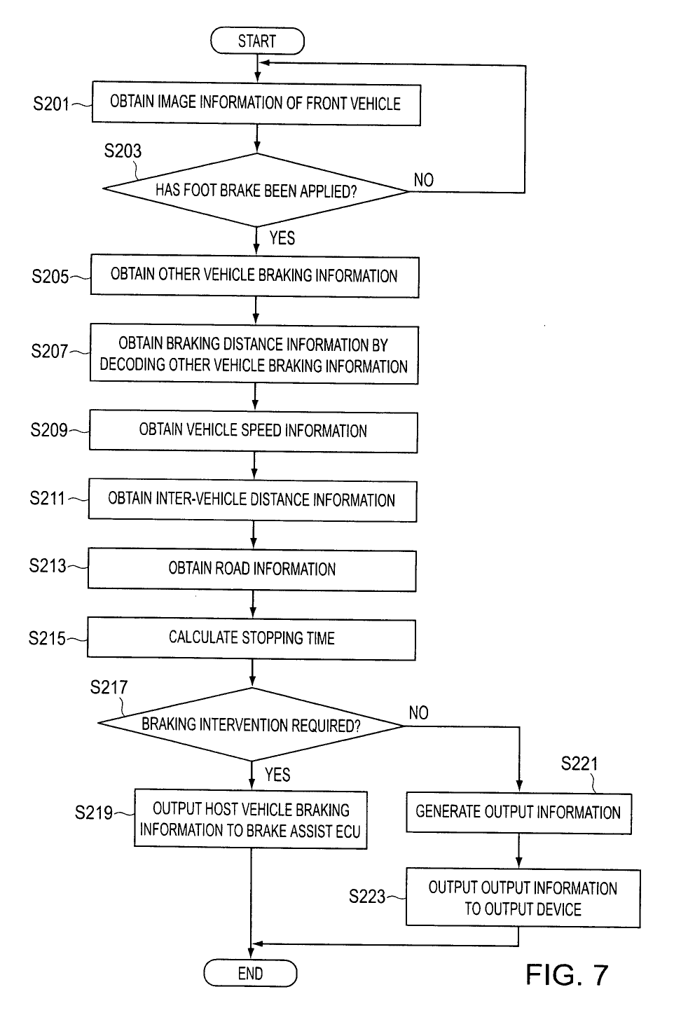

Next, an exemplary driving assistance method will be described with reference to FIGS. 7-8C. Again, the exemplary method may be implemented, for example, by one or more components of the above-described system. However, even though the exemplary structure of the above-described system may be referenced in the description, it should be appreciated that the structure is exemplary and the exemplary method need not be limited by any of the above-described exemplary structure. That is, for example, the method may be executed by the navigation device 220 of the host vehicle 200 upon reception of the other vehicle braking information generated as described above and transmitted from the other vehicle 100.

The driving assistance method may be performed by the system program 222a, input program 222b, various information acquisition program 222d, braking distance information acquisition program 222e, stopping time calculation program 222f, and output program 222g in parallel with the navigation processing described above, and therefore, similarly to the other vehicle braking information provision processing performed by the navigation device 120, the processing may be activated automatically by the system program 222a immediately after activation of the navigation device 220, and when the series of processes is complete, the processing is executed again from the start.

As shown in FIG. 7, image information relating to the other vehicle 100 traveling in front is obtained in step S201. Specifically, image information of the rear of the other vehicle 100, which is output by the front camera 233, may be obtained via the various information acquisition program 122d.

Next, in step S203, it is determined whether the foot brake has been applied. Specifically, image analysis may be performed based on the image information obtained in the step S201, and a determination may be made as to whether the brake lamp 146 of the other vehicle 100 is illuminated. When the brake lamp 146 is illuminated, it is determined that the foot brake has been applied (Yes in S203), and the method advances to step S205. When the brake lamp 146 is not illuminated, it is determined that the foot brake has not been applied (No in S203), and the routine returns to step S201 and obtains new image information. In other words, steps S201 and S203 may be repeated until the foot brake is applied.

In the step S205, the other vehicle braking information is obtained. Specifically, the other vehicle braking information of the navigation device 120, which is output by the front camera 233, may be obtained via the various information acquisition program 222d.

Next, in step S207, the braking distance information is obtained by decoding the other vehicle braking information obtained in step S205. This may be performed by the braking distance information acquisition program 222e, and may involve an error detection calculation and an error correction calculation based on the check sum detection code, cyclic redundancy check code, and so on that may be attached in the other vehicle braking information sent by the navigation device 120. Unless a data error is detected or an uncorrectable data error exists, the data may be used as the braking distance information.

In step S209, vehicle speed information is obtained. For example, information relating to the current speed of the host vehicle 200 may be obtained from the sensor control ECU 240 via the various information acquisition program 222d.

In a step S211, the inter-vehicle distance information is obtained. Specifically, the inter-vehicle distance information output by the millimeter wave radar 232 may be obtained via the various information acquisition program 222d.

In a step S213, road information is obtained. For example, road data such as the gradient value of the road along which the host vehicle 200 is currently traveling may be obtained from the road information stored in the road information database 223. For this purpose, first, the current position information of the host vehicle 200 may be obtained from the GPS sensor 234, and road data (the gradient value and so on) corresponding to longitude/latitude coordinate information based on the current position information may be obtained from the road information database 223. Note that this information may be obtained via the various information acquisition program 222d.

When the braking distance information of the other vehicle 100, the inter-vehicle distance information relating to the other vehicle 100, the current speed information of the host vehicle 200, and the gradient value and so on of the road along which the host vehicle 200 is traveling have been obtained in this manner, in step S215 a deceleration G/stopping time may be calculated. This processing may be performed by the stopping time calculation program 222f.

Because these calculations can be understood more easily with reference to FIG. 6, FIG. 6 will be referred to as the calculations are described. Note that parameter definitions and the like are similar to those described above.

First, the acceleration a₀ (deceleration rate) may be determined from an arbitrary deceleration G, which may vary according to differences in the brake device of the host vehicle 200 or the braking characteristic of the driver, using the following Equation (5). In Equation (5), g denotes gravitational acceleration. Note that the arbitrary deceleration G may be set at, for example, “0.5 G” in the case of a comparatively strong braking characteristic and at “0.3 G” in the case of a comparatively weak braking characteristic. In the case of an average braking characteristic corresponding substantially to the center of the aforementioned values, the arbitrary deceleration G may be set at, for example, “0.4 G.”
a₀=G·g (5)

Next, by setting the acceleration a₀ determined in Equation (5) as aₙ and inserting the current vehicle speed of the host vehicle 200 into the aforementioned Equation (1) as vₙ, the braking distance S may be determined. As above, a determination is then made as to whether the braking distance S is greater than the distance Sₙ to the next gradient changing point (n−1), and the braking distance S is determined continuously using Equations (2) and (1) until the determined braking distance S is smaller than the distance Sₙ₊ₘ to the next gradient changing point n+m.

In parallel with this processing, a time tₙ required to travel between each gradient changing point is determined using the following Equation (6), and by determining the sum total of this time using the following Equation (7), a time T required for braking from the current position ST to the stopping position SP can be calculated.

$$\begin{matrix}{t}_{n} = \frac{{v}_{n + 1} - {v}_{n}}{{a}_{n}} & ( 6 ) \\ T = {\sum }_{n = 0}^{m - 1} {t}_{n} - \frac{{v}_{m}}{{a}_{m}} & ( 7 ) \\ ( where if m = 0 , T = - \frac{{v}_{m}}{{a}_{m}} ) & \end{matrix}$$

For example, in the example shown in FIG. 6, when the vehicle speed of the host vehicle 200 in the current position ST is v₀ and the acceleration is a₀ (calculated using Equation (5)), the time (in seconds) required to travel a distance S₀ from the current position ST to the first gradient changing point a is determined from the above Equation (6) using the following Equation (8). Similarly, the time (in seconds) required to travel from the gradient changing point a to the next gradient changing point β is determined using the following Equation (9).

$$\begin{matrix}{t}_{1} = \frac{{v}_{2} - {v}_{1}}{{a}_{1}} & ( 8 ) \\ {t}_{0} = \frac{{v}_{1} - {v}_{0}}{{a}_{0}} & ( 9 )\end{matrix}$$

In this example, the host vehicle 200 stops before reaching the next gradient changing point γ, and therefore the time required for the host vehicle 200 to travel the braking distance L, or in other words the time T required from the start of braking to stopping, may be determined using the following Equation (10).

$$t = {\sum }_{n = 0}^{1} {t}_{n} - \frac{{v}_{2}}{{a}_{2}} = {t}_{o} + {t}_{1} - \frac{{v}_{2}}{{a}_{2}} \qquad ( 10 )$$

Once the stopping time T has been calculated in this manner, in step S217, it is determined whether braking intervention is required. Specifically, when the stopping time calculated in step S215 (the length of time required for the host vehicle 200 to stop from the start of braking), is equal to or greater than a predetermined time (e.g., 4 sec.) (No in S217), either the display 226 or the sound source unit 228 may selected as an output destination for the host vehicle braking information, and when the stopping time is less than the predetermined time (Yes in S217), the brake assist ECU 210 may be selected as the output destination for the host vehicle braking information.

In step S219, it is assumed that a degree of urgency is high and there may not be enough time for the driver of the host vehicle 200 to perform a braking operation. In this processing, the various information (inter-vehicle distance information, current vehicle speed information, and the stopping time) obtained may be output to the brake assist ECU 210 as the host vehicle braking information. This may be done by the output program 222g, and may involve transmitting the host vehicle braking information to the brake assist ECU 210 via the communication control unit 235.

Thus, upon reception of the host vehicle braking information, the brake pressure required to generate a sufficient braking force to stop the host vehicle 200 may be generated by the brake assist ECU 210 based on the host vehicle braking information, and as a result, forcible braking control can be performed when there is not enough time for the driver of the host vehicle 200 to perform a braking operation.

In step S221, it is assumed the degree of urgency is low, and there is enough time for the driver of the host vehicle 200 to perform a braking operation. Thus, output information (notification information) based on the various information (inter-vehicle distance information, current vehicle speed information, and the stopping time) obtained may be generated using the various information as the host vehicle braking information.

For example, when the display 226 has been selected in advance as the output device, braking distance information centering on information regarding a recommended brake pressure and information regarding a corresponding braking distance is generated for a case in which the brake pressure is greater or smaller. On the other hand, when the sound source unit 228 is selected in advance as the output device, voice information capable of expressing the brake pedal pressure in phrases such as “strong,” “normal,” and/or “weak,” or voice information capable of expressing the brake pedal depression amount in phrases such as “deep,” “normal,” and/or “slight,” may be generated as the information relating to the recommended brake pressure. Note that this may be performed by the output program 222g.

Next, in step S223, the output information generated in the step S221 may be output to the pre-selected output device (e.g., the display 226 or the sound source unit 228). As shown in FIG. 8A, for example, when the display 226 has been selected, a circle display X capable of expressing the information regarding the recommended brake pressure by the size of its diameter and a rod-shaped display Y capable of expressing the corresponding braking distance information by its length may be displayed. A gauge Z clarifying the diameter of the circle display X may be displayed in relation to the brake pressure indicated by the circle display X, and a vehicle display W clarifying the position of the other vehicle 100 traveling in front is displayed in relation to the braking distance indicated by the rod-shaped display Y.

The recommendation screen display shown in FIG. 8A is output to the display 226 initially, and when the driver of the host vehicle 200 operates the brake pedal, a screen display which changes according to the brake pedal depression amount is displayed (FIGS. 8B and 8C). As shown in FIG. 8B, for example, on this screen, when the brake pedal depression amount is large, the diameter of a circle display X′ increases and the length of a rod-shaped display Y′ indicating the braking distance decreases. On the other hand, as shown in FIG. 8C, when the brake pedal depression amount is small, the diameter of a circle display X″ decreases and the length of a rod-shaped display Y″ indicating the braking distance increases.

As described above, according to the exemplary driving support system, other vehicle braking information relating to a braking operation of the other vehicle 100 may be generated by, for example, the braking distance information generating program 122e and other vehicle braking information generating program 122f in the navigation device 120 of the other vehicle 100 (S113, S115). This information may be output to the lamp control ECU 140 by, for example, the output program 122g (S117). In such a manner, optical data is transmitted to the exterior of the other vehicle 100 through the brake lamp 146.

The other vehicle braking information output by the navigation device 120 of the other vehicle 100 is obtained by the various information acquisition program 222d of the navigation device 220 in the host vehicle 200 (S205. On the basis thereof, host vehicle braking information relating to a braking operation of the host vehicle 200 may be generated by the braking distance information acquisition program 222e and the stopping time calculation program 222f (S207, S215). As a result, the host vehicle braking information may be output to the display 226, the sound source unit 228, or the brake assist ECU 210 by the output program 222g (S219, S223).

Thus, in comparison with a conventional device, in which host vehicle braking information is generated based on nothing more than detection information obtained from a detection device such as a radar device or a vehicle speed sensor, the above described exemplary systems and methods provide vehicle braking information relating to the braking operation of the host vehicle 200 that is generated based on information in addition to the vehicle speed information of the other vehicle 100 and inter-vehicle distance information. Accordingly, more accurate braking information can be generated. In other words, the future behavior of the other vehicle 100 may be predicted to a certain extent based on the other vehicle braking information relating to the braking operation of the other vehicle 100. Therefore the host vehicle braking information can be generated taking the predictable future behavior of the other vehicle 100 into account. Hence, appropriate driving support can be provided by the brake assist ECU 210, display 226, and so on, based on the host vehicle braking information.

Further, according to the exemplary systems and methods, may cause the other vehicle 100 side navigation device 120 to generate other vehicle braking information relating to a braking operation of the other vehicle 100 (S113, S115), to output the information to the lamp control ECU 140 (S117), and to transmit optical data generated by the brake lamp 146 to the exterior of the other vehicle 100. Further, the exemplary systems and methods allow the navigation device 220 to obtaining the other vehicle braking information output by the navigation device 120 of the other vehicle 100 (S205), to generate host vehicle braking information relating to a braking operation of the host vehicle 200 based on this information (S207, S215), and to output the host vehicle braking information to the display 226, the sound source unit 228, or the brake assist ECU 210 (S219, S223).

Thus, in the navigation device 220, the host vehicle braking information relating to the braking operation of the host vehicle 200 may be generated based on the other vehicle braking information relating to the braking operation of the other vehicle 100, in addition to the vehicle speed information of the other vehicle 100 and the inter-vehicle distance information. Therefore, similarly to the driving support system, appropriate driving support can be provided by the brake assist ECU 210, display 226, and so on, which serve as a predetermined output destination of the navigation device 220, based on the host vehicle braking information.

Note that in the above examples, optical data transmission performed by the lamp control ECU 140 and the brake lamp 146 is a device (other vehicle information outputting device) for transmitting the other vehicle braking information from the navigation device 120 (first in-vehicle device) to the navigation device 220 (driving support device, second in-vehicle device). Alternatively, or additionally, any wireless transmission medium that is capable of transmitting binary data, for example wireless data transmission through microwaves or millimeter waves, or sound wave data transmission in a non-audible high frequency or low frequency, may be employed.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A driving support device for a host vehicle, the device comprising:
a sensor that receives braking information from another vehicle traveling in front of the host vehicle; and
a controller that:
obtains current speed information of the host vehicle;
obtains inter-vehicle distance information indicating a distance between the other vehicle and the host vehicle;
generates host vehicle braking information based on the other vehicle braking information, the vehicle speed information, and the inter-vehicle distance information, the host vehicle braking information recommending a braking operation for the host vehicle; and
controls the host vehicle based on the host vehicle braking information.

2. The driving support device according to claim 1, wherein the controller controls the vehicle by automatically braking the host vehicle based on the host vehicle braking information.

3. The driving support device according to claim 1, wherein the controller controls the vehicle by outputting the host vehicle braking information to a notifying device, the notifying device capable of generating and outputting notification information, the notification information enabling a driver of the host vehicle to recognize a need to perform a braking operation.

4. The driving support device according to claim 3, wherein the notifying device notifies a driver of at least one of:
information regarding an appropriate braking amount for stopping the host vehicle without contacting the other vehicle; and
information regarding a braking distance of the host vehicle when the appropriate braking amount is applied.

5. The driving support device according to claim 1, wherein the controller:
determines deceleration rate information indicating a rate at which the host vehicle decelerates, and stopping time information indicating a time required for the host vehicle to stop traveling from a beginning of a braking operation; and
based on the deceleration information, the stopping time information, and the host vehicle braking information, controls the vehicle by at least one of:
automatically braking the host vehicle based on the host vehicle braking information; and
outputting the host vehicle braking information to a notifying device, the notifying device capable of generating and outputting notification information, the notification information enabling a driver of the host vehicle to recognize a need to perform a braking operation.

6. The driving support device according to claim 1, wherein the sensor is at least one of a camera, an infrared camera, a speaker, a microwave receiver, and a millimeter wave receiver.

7. The driving support device according to claim 1, further comprising:
a braking information output device that outputs host vehicle braking information related to braking operations of the host vehicle;
wherein the controller encodes the braking operations of the host vehicle and causes the braking information output device to output the encoded braking operations of the host vehicle as the host vehicle braking information.

8. The driving support device according to claim 7, wherein the braking information output device is at least one of a high intensity LED, an infrared LED, a speaker, a microwave transmitter, and a millimeter wave transmitter.

9. A driving support system, comprising:
the driving support device of claim 1; and
another vehicle braking information generating device that transmits the other vehicle braking information, the other vehicle braking information generating device including:
a braking information output device that outputs the other vehicle braking information; and
a controller that encodes braking operations of the other vehicle and causes the braking information output device to output the encoded braking operations of the other vehicle as the other vehicle braking information.

10. A navigation system comprising the device of claim 1.

11. A driving support method for a host vehicle, the method comprising:
receiving braking information from another vehicle traveling in front of the host vehicle; and
obtaining current speed information of the host vehicle;
obtaining inter-vehicle distance information indicating a distance between the other vehicle and the host vehicle;
generating host vehicle braking information based on the other vehicle braking information, the vehicle speed information, and the inter-vehicle distance information, the host vehicle braking information recommending a braking operation for the host vehicle; and
controlling the host vehicle based on the host vehicle braking information.

12. The driving support method according to claim 11, further comprising controlling the vehicle by automatically braking the host vehicle based on the host vehicle braking information.

13. The driving support method according to claim 11, further comprising:
controlling the vehicle by outputting the host vehicle braking information to a notifying device;
generating and outputting notification information, the notification information enabling a driver of the host vehicle to recognize a need to perform a braking operation.

14. The driving support method according to claim 13, further comprising notifying a driver of at least one of:
information regarding an appropriate braking amount for stopping the host vehicle without contacting the other vehicle; and
information regarding a braking distance of the host vehicle when the appropriate braking amount is applied.

15. The driving support method according to claim 11, further comprising:
determining deceleration rate information indicating a rate at which the host vehicle decelerates, and stopping time information indicating a time required for the host vehicle to stop traveling from a beginning of a braking operation; and
based on the deceleration information, the stopping time information, and the host vehicle braking information, controlling the vehicle by at least one of:
automatically braking the host vehicle based on the host vehicle braking information; and
outputting the host vehicle braking information to a notifying device, the notifying device capable of generating and outputting notification information, the notification information enabling a driver of the host vehicle to recognize a need to perform a braking operation.

16. The driving support method according to claim 11, wherein the other vehicle braking information is received by at least one of a camera, an infrared camera, a speaker, a microwave receiver, and a millimeter wave receiver.

17. The driving support method according to claim 11, further comprising:
outputting host vehicle braking information related to braking operations of the host vehicle;
encoding the braking operations of the host vehicle; and
outputting the encoded braking operations of the host vehicle as the host vehicle braking information.

18. The driving support method according to claim 17, wherein the host vehicle braking information is output by at least one of a high intensity LED, an infrared LED, a speaker, a microwave transmitter, and a millimeter wave transmitter.

19. A driving support method of claim 11, further comprising:
transmitting the other vehicle braking information;
encoding braking operations of the other vehicle; and
outputting the encoded braking operations of the other vehicle as the other vehicle braking information.

20. A storage medium storing a set of program instructions executable on a data processing device, the instructions usable to implement the method of claim 11.
